(19) United States
(12) Patent Application Publication
(10) Pub. No.: US 2015/0003894 A1
(43) Pub. Date: Jan. 1, 2015

(54) Self-Aligning End-On Butt Connectors

(71) Applicant: George Alfred Legg, Hico, WV (US)

(72) Inventor: George Alfred Legg, Hico, WV (US)

(21) Appl. No.: 14/320,852

(22) Filed: Jul. 1, 2014

Related U.S. Application Data
(60) Provisional application No. 61/841,599, filed on Jul. 1, 2013.

(51) Int. Cl. F16B 7/00; F16B 17/00

(52) U.S. Cl. CPC F16B 7/00; F16B 17/00
USPC 403/14

(57) ABSTRACT

The present invention is self-aligning connector having first and second support structures and a collar. In some embodiments the first support structure has a wedge, the second support structure has a wedge receiving structure, and the collar has a pointed lock. In other embodiments a lateral support structure is supported by a first support structure by means of an L-shaped support structure and a plurality of tubes. In these embodiments the L-shaped support structure has a triangular support piece designed and configured to be received by said lateral support structure. Slidable tubes with pins or receivers lock the structures together.

### BACKGROUND OF THE INVENTION

The present invention regards a design for an end-on butt connector which is self-aligning, multi-point and self-locking, without the use of any tools, threads, hammers or separate pins.

End-on butt connectors are useful for structures comprising vertical members and, in some embodiments, horizontal elements, allowing for easy assembly and disassembly, including movable structures for industrial use as well as storage shelves.

### GENERAL DESCRIPTION OF THE INVENTION

The present invention is self-aligning connector having first and second support structures and a collar.

The first support structure has interior and exterior surfaces that define an interior width and length and an exterior width and length, and the structure includes a wedge having an upper portion and a lower portion, where the upper portion of the wedge ahs first and second ends, each end having a triangular-shaped cross-section with a base thereof having a width less than the interior width of the first support structure. The wedge has a pin protruding from the first end of the wedge a length to cause the distal end of the pin to be aligned at or about a plane from the corresponding exterior surface of the first support structure. The wedge is securely affixed to the first support structure, with the upper portion of the wedge at its base extending along its length from an interior surface of the first support structure to an opposing exterior surface of the first support structure. The lower portion of the wedge has a height of, and extends into said first support structure by, at least ½″.

The second support structure has an inverted wedge receiver, sized to receive and accommodate the wedge. The second support structure is defined by a first side having an aperture sized and positioned to receive the round pin when the wedge is fully inserted into the wedge receiver. On the opposing side of the second support structure the structure extends to provide a receptacle which forms the exterior surface of the structure. The wedge has a width smaller than the width of the inverted wedge receiver, so that said wedge with said pin protruding can be received in the wedge receiver.

The collar includes a pointed lock extending from the bottom of one side of said collar. The interior dimensions of the collar are larger than the exterior dimensions of said first support structure. Furthermore, the receptacle of the second support structure is positioned and dimensioned to receive said pointed lock.

The present invention also regards a self-aligning connector that has a first support structure, second support structure and a collar.

The first support structure has interior and exterior surfaces defining an interior width and length and an exterior width and length, and has a wedge with an upper portion and a lower portion. The upper portion of the wedge has first and second ends, each end having a triangular-shaped cross-section with a base thereof having a width less than the interior width of the first support structure. The wedge is securely affixed to the first support structure, with the upper portion of the wedge at its base extending along its length from an interior surface of the first support structure to an opposing exterior surface of the first support structure. The lower portion of the wedge has a height of, and extends into the first support structure by, at least ½″.

The second support structure has an inverted wedge receiver, sized to receive and accommodate said wedge, and on said opposing side of the second support structure the structure extends to provide a receptacle which forms the exterior surface of said structure.

The collar has a pointed lock extending from the bottom of one side of said collar, wherein the interior dimensions of said collar are larger than the exterior dimensions of said first support structure. The receptacle of the second support structure is positioned and dimensioned to receive the pointed lock.

In this embodiment the invention includes a scissor lock incorporated into the inside of said wedge, with an anchor pin affixed to the wedge along its length to secure the upper most portion of the scissor lock. Apertures in the ends of the wedge receive the sides of the scissor lock, and an aperture in the bottom of the wedge receives the bottom of the scissor lock. A round rod rotatably mounted under or at the bottom of the wedge receiver, with a release point cut therein, is included to release the scissor lock from its locked position.

The present invention also regards a self-aligning connector having a lateral support structure, a first vertical support structure, an L-shaped element affixed along the first vertical support structure, having a lateral portion, and a vertical portion, with a triangular structure affixed to the top of the lateral portion. Also included is a first slidable tube in sliding engagement with the first vertical support structure, above the L-shaped element. The first slidable tube has interior dimensions larger than the exterior dimensions of the vertical support structure. The first slidable tube has a post receiver welded to a side of the tube.

The lateral support structure here has a lip at the proximal end thereof and an inverted triangular support, so that the triangle of the L-shaped element may be received in the lateral support structure. A second slidable tube is also included, with interior dimensions greater than the exterior dimensions of the lateral support structure. This second slidable tube has a pin affixed to the exterior surface thereof.

### DESCRIPTION OF THE DRAWINGS

FIG. 1 is a perspective view of first and second support structures of an embodiment of the present invention, from a first side.

FIG. 2 is a perspective view of first and second support structures of an embodiment of the present invention, from a second side.

FIG. 3 is a perspective view of a collar of an embodiment of the present invention.

FIG. 4 is a perspective view of an embodiment of the present invention, partially and fully assembled.

FIG. 5 is a cut-out view of first and second support structures and a wedge and wedge receiver of an embodiment of the present invention.

FIG. 6 is a cutout view of first and second support structures, a wedge and a wedge receiver, and a scissor lock and related components of an embodiment of the present invention.

FIG. 7 is a front view of a 90 degree support system of an embodiment of the present invention.

FIG. 8 is a front view of the vertical support structure and engaging elements of an embodiment of the present invention.

FIG. 9 is a bottom view of the underside of a lateral support structure of an embodiment of the present invention.

FIG. 10 is a front view of the lateral support structure in process of being removably affixed to the vertical support structure of an embodiment of the present invention.

FIG. 11 is a front view of an embodiment of the present invention.

FIG. 12 is a front view of another embodiment of the present invention.

### DETAILED DESCRIPTION OF THE INVENTION

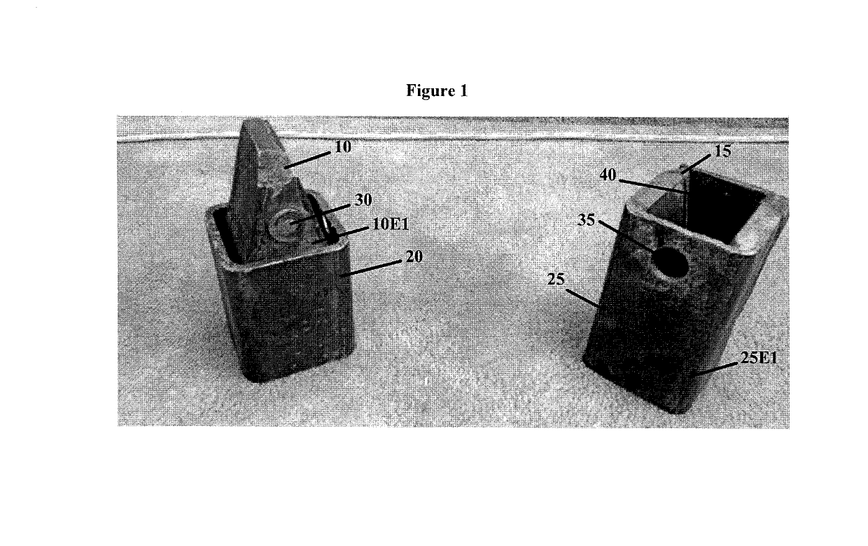

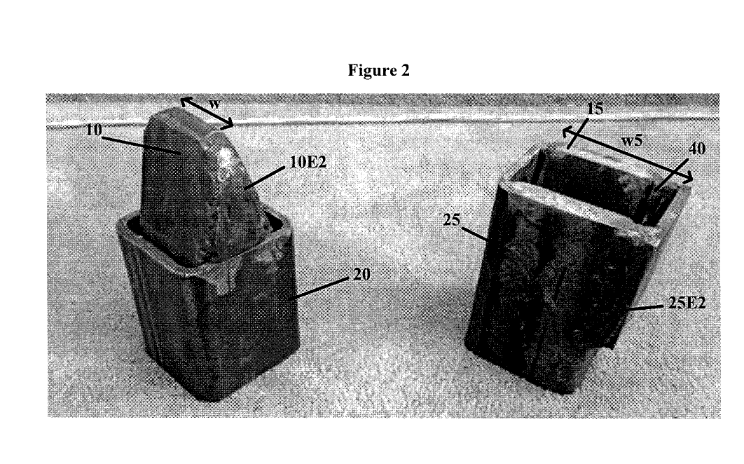

As shown in FIGS. 1-6, embodiments of the invention comprise a wedge 10 having an upper portion and a lower portion, wherein the wedge is securely affixed to or manufactured as a part of the end of a first support structure 20 in the form of a tube or pipe. The first support structure comprises walls having an interior and exterior, defining an interior width and length and an exterior width and length. The wedge 10 may be hollow or solid. The upper portion of the wedge 10 has first and second ends 10E1 and 10E2, each end having a triangular-shaped cross-section, with the base thereof having a width equivalent to or up to 10%, or in some embodiments 20%, smaller than the width of the interior of the first support structure 20. The upper portion of the wedge at its base extends at the first end 10E1 to the corresponding interior wall of the first support structure 20, and at the second end 10E2 to the corresponding exterior walls of the structure 20, so that said end is flush with the corresponding side of the first support structure 20 (as shown in FIG. 2).

As shown in FIG. 1, a round pin 30 protrudes from the first end 10E1 of the wedge, preferably although not necessarily near the center of the upper portion of the wedge 10. The pin 30 protrudes from the first wedge end 10E1 a length to cause the distal end of the pin to be aligned at or about a plane from the corresponding exterior wall of the first support structure 20.

In some embodiments, the lower portion of the wedge has a height of, and extends into the first support structure 20 by, at least ½″, in some embodiments the height is 2″ or more. The lower portion of the wedge may have a rectangular cross-section, with a width and length equivalent to the interior dimensions of the first support structure 20 so that the wedge is securely affixed to or integrated into the structure. The exposed top surface of the lower portion of the wedge, if any, is preferably positioned at the top of the first support structure 20; however, in some embodiments the top is positioned above the top of the structure, and in other embodiments the top of the lower portion of the wedge is positioned below the top of the structure. In other embodiments the lower portion of the wedge 10 is a continuation of the wedge shape into the first support structure 20, and welded near the ends thereof to the interior of the structure 20.

Although the upper and lower portions of the wedge 10 may be manufactured as separate elements and secured together by welding or similar methods, they may also be manufactured as a single unit. Similarly, the wedge 10 and the first support structure 20 may be manufactured as separate elements and secured together by welding or other means, or may be manufactured as a single unit.

Embodiments of the present invention further comprise an inverted wedge receiver 15 fixed within a lower support structure 25, sized to receive and accommodate the wedge 10. The wedge receiver 15 may be a pair of plates welded to opposing sides of the interior of the second support structure 25, in the shape of an inverted wedge, or may be a block with an inverted wedge incorporated therein. A first side 25E1 of the second support structure 25 comprises an aperture 35 sized and positioned to receive said round pin 30 when the wedge 10 is fully inserted into the wedge receiver 15, as hereinafter described.

On the opposing side of the second support structure 25, the structure extends to provide a receptacle 40 which forms the exterior surface of the structure 25, positioned and dimensioned to receive the pointed lock 50 as hereinafter described.

The wedge 10 has a width w smaller than the width w5 of the inverted wedge receiver 15, so that the wedge with the pin 30 protruding from the first end thereof can be received in the wedge receiver, and the wedge can then be slid over to position the pin 30 in the aperture 35. Preferably the outer dimensions of the first support structure 20 and the outer dimensions of the second support structure 25 are the same dimensions on three sides; with the width w5 of the second support structure 25 being larger than the width of the first support structure 20, to receive the pointed lock as hereinafter described.

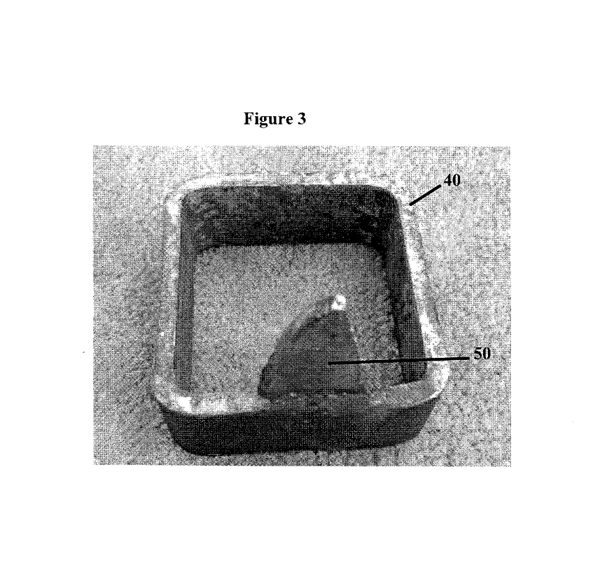

As shown in FIG. 3, embodiments of the present invention further comprise a collar 40, having a pointed lock 50 extending from the bottom of one side of said collar. The interior dimensions of said collar 40 are larger than the exterior dimensions of the first support structure 20, so that the collar 40 with the pointed lock 50 can slide over said first support structure 20. The collar 40 has a height of between ½″ to 3″; preferably between 1″ and 1½″. The pointed lock 50 is preferably shaped as an arrow or similar shape.

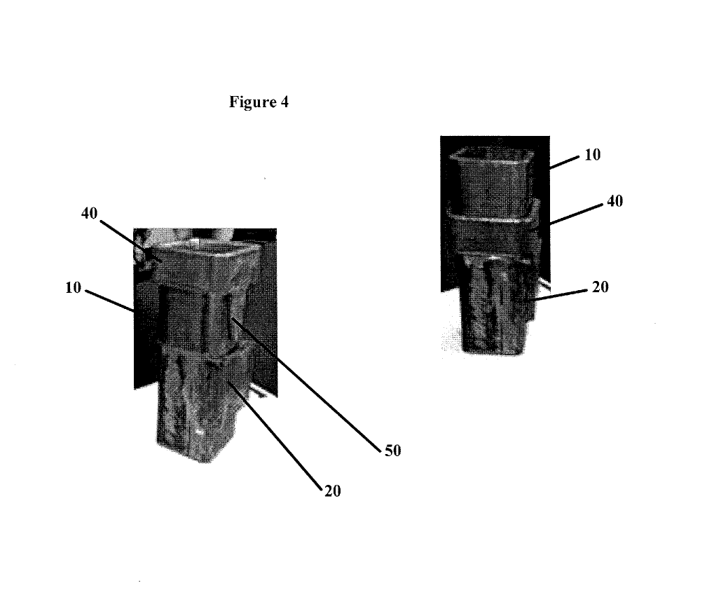

As shown in FIG. 4, to assemble this embodiment of the present invention the first support structure 20 is positioned over the second support structure 25, so that the wedge 10 is positioned within the wedge receiver 15. The first support structure 20 is then moved over so that the pin 30 is positioned within the aperture 35 of the second support structure 25. The collar 40 is slid over the first support structure 20, so that the pointed lock 50 is positioned within the receptacle 40 of the second support structure 25. This arrangement prevents side movement of the wedge, and locks the tubes together.

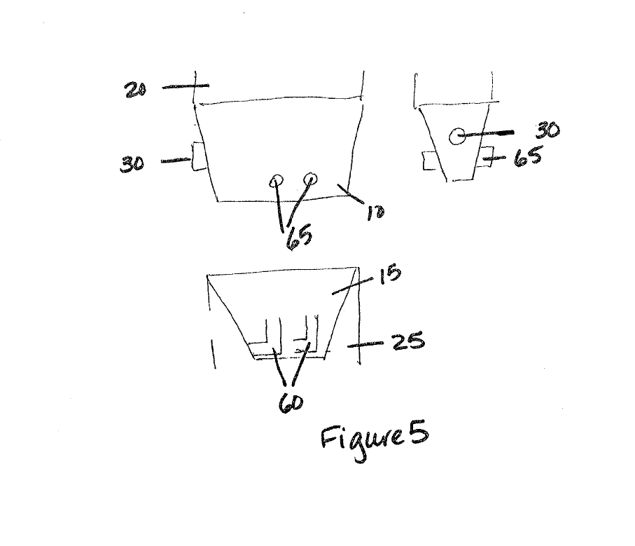

In some embodiments of the present invention, as shown in FIG. 5, the wedge receiver 15 has one or more L shaped slots 60 recessed in or cut through, and positioned on each side of the wedge receiver 15; the slots are sized and configured to receive corresponding pins 65 affixed to the wedge 10 when the wedge is inserted into the wedge receiver; when the wedge is fully inserted into the wedge receiver, and shifted towards the aperture 35 of the second support structure 25, the pins likewise shift into the lower portion of the L shaped slots of the wedge receiver 15, to further secure the wedge 10 to the wedge receiver 15.

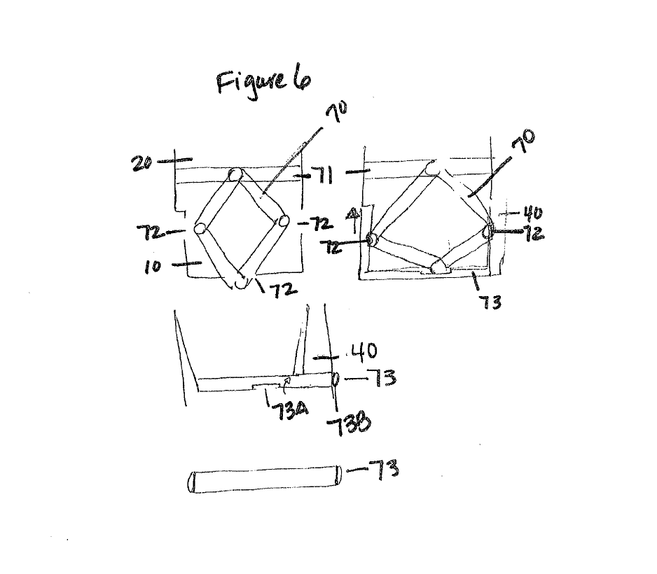

As shown in FIG. 6, in other embodiments of the present invention, in lieu of the pins as hereinabove described a scissor lock, quick lock or snap lock 70 is incorporated into the inside of the wedge. An anchor pin 71 affixed to the interior of the wedge 10 or the first support structure 20 holds the upper most portion of the scissor lock 70; apertures 72 are incorporated into the ends of the wedge to receive the sides of the scissor lock 70 when the same is compressed, and into the bottom of the wedge 10 to allow the lower element of the scissor lock to freely move into and outside of the wedge. A round rod 73 is rotatably mounted under or at the bottom of the wedge receiver 15, with a release point 73A cut therein. When the wedge 10 is inserted into the wedge receiver 15, the scissor lock 70 is compressed from the bottom by means of the round rod 73, and the sides of the scissor lock protrude through side apertures 72 of the wedge into corresponding apertures of the second support structure 25. Rotation of the rod 73 allows the release point 73A to engage with the lower element of the scissor lock and release the tension therein, allowing release of the sides of the scissor lock from the corresponding apertures 72 in the wedge, and the lock is released. The rod 73 is rotatable by means of a knob or lever 73B affixed to and engaged with the rod, accessible on the outside of the second support structure 25.

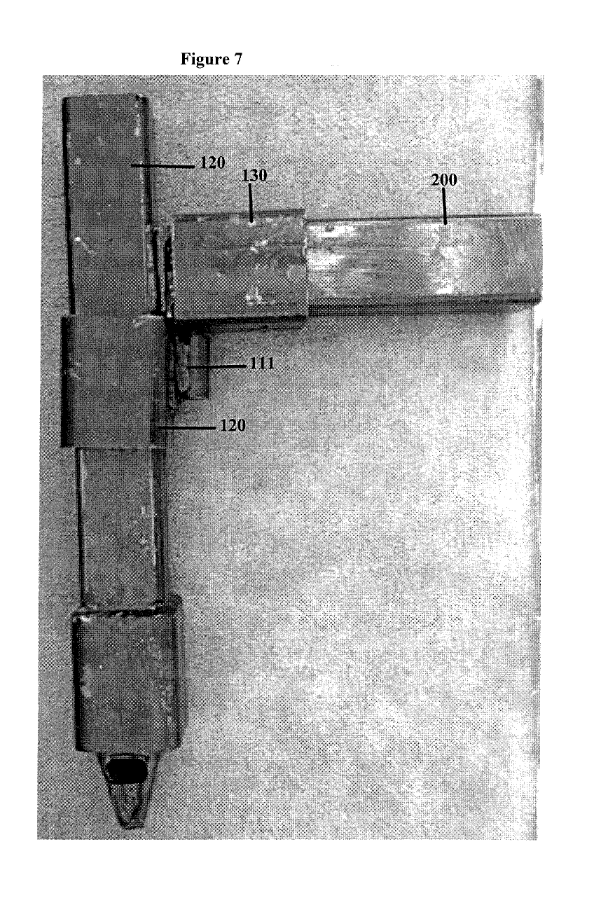

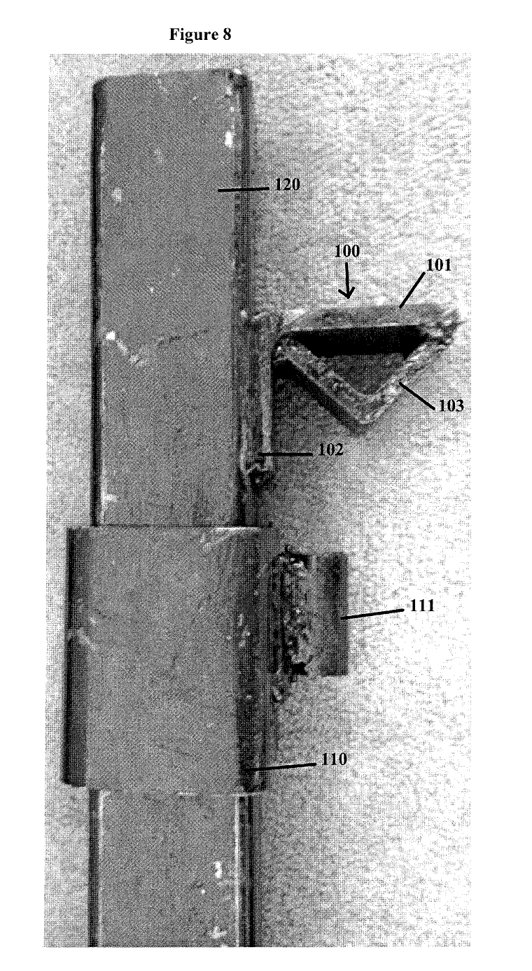

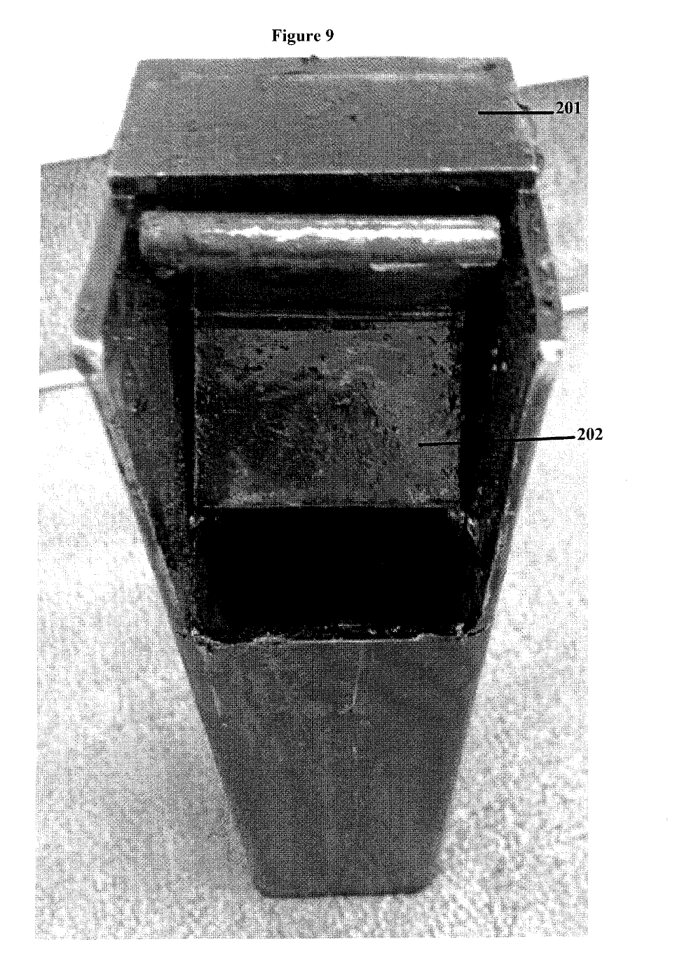

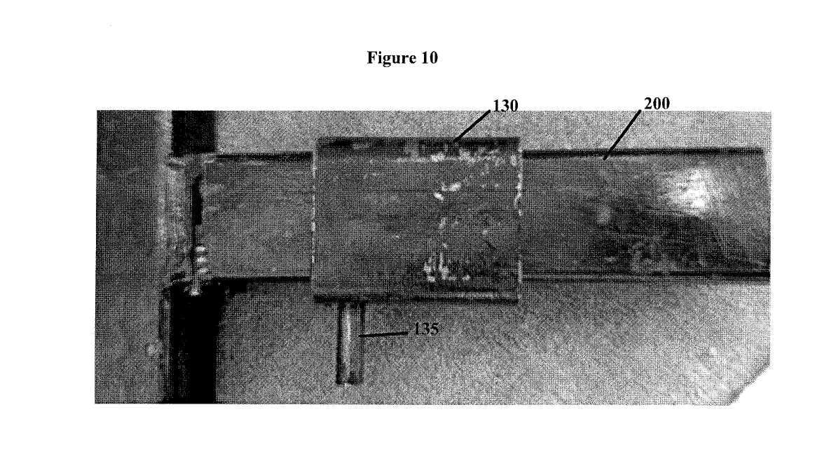

In other embodiments of the present invention depicted in FIGS. 7-10, a lateral support structure 200 may be affixed to a first vertical support structure 120, at a 90 degree angle. In these embodiments, an L-shaped element 100 is affixed along the tube 120, having a lateral portion 101, a vertical portion 102, with a triangular structure 103 affixed to the top of said lateral portion 101. A slidable tube 110 is in sliding engagement with said first vertical support structure 120, above said L-shaped element 100. Tube 110 has interior dimensions larger than the exterior dimensions of the first vertical support structure 120, to allow sliding engagement thereof. Welded to the bottom of said tube 110 is a post receiver 111.

Lateral support structure 200 has a lip 201 at the top proximal end thereof, and an inverted triangular support 202 from the top side of said structure, so that the triangle 103 of the L-shaped element 100 may be received in the lateral support structure, and as the lateral support structure is positioned on the vertical portion 102 at the L-shaped element 100, it will retain the same. The invention further comprises a slidable tube 130, with interior dimensions greater than the exterior dimensions of the tube 200, allowing the slidable tube 130 to slide on the outside of the lateral support structure 200. The slidable tube has a pin 135 affixed to the top surface thereof.

In this 90 degree attachment embodiment, the lateral support structure 200 is inserted over the L-shaped element 100, with the triangle secured by the lip and the inverted triangle of lateral support 200. The slidable tube 130 is then slid over the structure 200 until abutted against the proximal end of the tube 120, and the slidable tube 110 is slid down so that the pin 135 of the tube 130 is received in the post receiver 111.

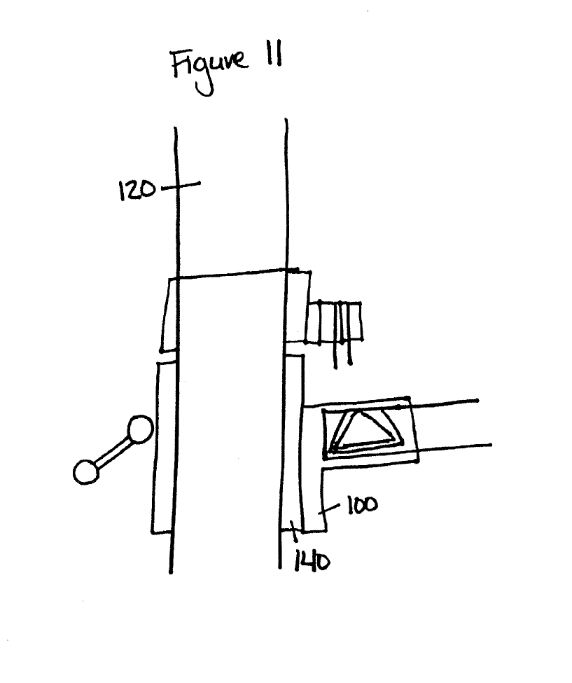

Shown in FIG. 11 is another embodiment of this 90 degree connector, wherein the L-shaped element 100 is affixed to another slidable tube 140, capable of sliding up and down the first support structure 120, with a lock on the opposing side of the tube to secure the same in position on the tube 120. The lock may be a cam lock consisting of a lever attached to a round rod, having a flat surface, and a lobe on the round rod on the interior of the tube 140. An aperture is incorporated into the side of the tube 140, and outside ledges are incorporated on said tube. When the lever is rotated, the lobe rotates, causing the same to lock the tube 140 to the vertical support structure 120.

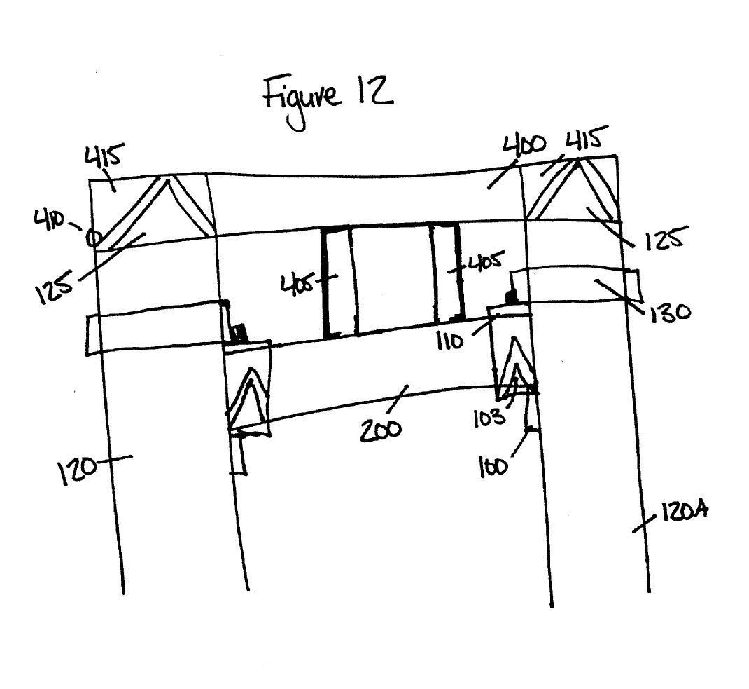

In other embodiments of the present invention, as depicted in FIG. 12, the lateral support structure 200 is removably affixed to a pair of vertical support structures 120 and 120A, in the manner as hereinabove described for a single vertical support structure—by means of L-shaped elements 100, having triangular structures 103 affixed to or slidingly engaged with the structures 120 and 120A. Inverted triangles and lips are incorporated into each end of the support structure 200 to receive said triangle structure 103. Sliding tubes 110 are in sliding engagement with said lateral support structure 200, above said L-shaped elements 100. Welded to a side of each of said tubes 110 is a pin. Slidable tubes 130, with interior dimensions greater than the exterior dimensions of the tubes 120 and 120A, each with post receivers, slide on the outside of each vertical support structure 120 and 120A, all as hereinabove described for a single post embodiment.

In this 90 degree attachment embodiment, the lateral support structure 120 is inserted over both L-shaped elements 100, with the triangles secured by the opposing lips of the structure 200. The tubes 110 are then slid over the lateral support structure 200 until each is abutted against an opposing end of the tube 200, and the tubes 130 are slid down the vertical support members 120 and 120A so that the pins 135 of the tubes 110 are received in the post receivers 111 of the tubes 130, respectively.

A second lateral support structure 400 is welded to said lateral support structure 200, by crossbars 405. Said second structure has fixed locking cams 410 on each end thereof, and wedge receivers 415 on opposing sides thereof to receive wedges 125 at the top of said vertical support structures 120 and 120A. The fixed locking cams comprise a rod with levers or knobs, said rods having a circular surface and a flat surface along the length thereof thereof. As the rod rotates within the structure, the circular portion of said rod hits a groove in the structure, and locks the second lateral support structure in place on each wedge 125. By this embodiment, slack which is otherwise present in the 90-degree embodiment of the present invention is eliminated.

Any combination of the embodiments of the present invention may be incorporated into a single structure.

1. A self-aligning connector comprising:
a. a first support structure comprising interior and exterior surfaces defining an interior width and length and an exterior width and length, and comprising a wedge having an upper portion and a lower portion, said upper portion of said wedge having first and second ends, each end having a triangular-shaped cross-section with a base thereof having a width less than the interior width of the first support structure;
i. said wedge comprising a pin protruding from said first end of said wedge a length to cause the distal end of the pin to be aligned at or about a plane from the corresponding exterior surface of the first support structure;
ii. wherein the wedge is securely affixed to said first support structure, with said upper portion of the wedge at its base extending along its length from an interior surface of said first support structure to an opposing exterior surface of the first support structure; and
iii. wherein the lower portion of the wedge has a height of, and extends into said first support structure by, at least ½″;
b. a second support structure comprising an inverted wedge receiver, sized to receive and accommodate said wedge, said lower support structure defined by a first side comprising an aperture sized and positioned to receive said round pin when said wedge is fully inserted into said wedge receiver; and on said opposing side of the second support structure the structure extends to provide a receptacle which forms the exterior surface of said structure;
c. wherein said wedge has a width smaller than the width of the inverted wedge receiver, so that said wedge with said pin protruding can be received in said wedge receiver;
d. a collar comprising a pointed lock extending from the bottom of one side of said collar, wherein the interior dimensions of said collar are larger than the exterior dimensions of said first support structure; and
e. wherein said receptacle of said second support structure is positioned and dimensioned to receive said pointed lock.

2. The self-aligning connector of claim 1, wherein the wedge is hollow.

3. The self-aligning connector of claim 1, wherein the upper and lower portions of the wedge are manufactured as a single unit.

4. The self-aligning connector of claim 1, wherein the wedge receiver comprises a pair of plates welded to opposing sides of the interior of the second support structure, in the shape of an inverted wedge.

5. The self-aligning connector of claim 1, wherein said wedge has one or more pins extending from the sides of said wedge, and said wedge receiver has one or more L shaped slots recessed in or cut through, and positioned on each side of said wedge receiver, sized and configured to receive said corresponding pins of said wedge.

6. A self-aligning connector comprising:
a. a first support structure comprising interior and exterior surfaces defining an interior width and length and an exterior width and length, and comprising a wedge having an upper portion and a lower portion, said upper portion of said wedge having first and second ends, each end having a triangular-shaped cross-section with a base thereof having a width less than the interior width of the first support structure;
i. wherein the wedge is securely affixed to said first support structure, with said upper portion of the wedge at its base extending along its length from an interior surface of said first support structure to an opposing exterior surface of the first support structure; and
ii. wherein the lower portion of the wedge has a height of, and extends into said first support structure by, at least ½″;
b. a second support structure comprising an inverted wedge receiver, sized to receive and accommodate said wedge, and on said opposing side of the second support structure the structure extends to provide a receptacle which forms the exterior surface of said structure;
c. a collar comprising a pointed lock extending from the bottom of one side of said collar, wherein the interior dimensions of said collar are larger than the exterior dimensions of said first support structure; and
d. wherein said receptacle of said second support structure is positioned and dimensioned to receive said pointed lock.
e. Further comprising a scissor lock incorporated into the inside of said wedge;
i. an anchor pin affixed to said wedge along its length to secure the upper most portion of the scissor lock;
ii. apertures in the ends of the wedge to receive the sides of the scissor lock, and an aperture in the bottom of the wedge; and
iii. a round rod rotatably mounted under or at the bottom of the wedge receiver, with a release point cut therein.

7. A self-aligning connector comprising:
a. a lateral support structure;
b. a first vertical support structure;
c. an L-shaped element affixed along the first vertical support structure, having a lateral portion, and a vertical portion, with a triangular structure affixed to the top of said lateral portion;
d. a first slidable tube in sliding engagement with said first vertical support structure, above said L-shaped element, said first slidable tube having interior dimensions larger than the exterior dimensions of said vertical support structure; said first slidable tube comprising a post receiver welded to a side of said tube;
e. wherein said lateral support structure has a lip at the proximal end thereof and an inverted triangular support, so that said triangle of said L-shaped element may be received in said lateral support structure;
f. further comprising a second slidable tube, with interior dimensions greater than the exterior dimensions of the lateral support structure, said second slidable tube comprising a pin affixed to the exterior surface thereof.

8. The self aligning connector of claim 7, wherein said L-shaped element is positioned on a third slidable tube, and comprises a cam lock on the opposing side of the tube.

9. The self aligning connector claim 7 further comprising:
a. a second vertical support structure;
b. a second L-shaped element, having a triangular structure, affixed to said second vertical support structure;
c. an inverted triangle and lip incorporated into said lateral support structure to receive said triangle structure;
d. a fourth sliding tube in sliding engagement with said lateral support structure, said tube comprising a pin;
e. a fifth slidable tube, comprising a post receiver; and
f. a second lateral support structure welded to said first lateral support structure by crossbars.

10. The self aligning connector of claim 9, where said second support structure has fixed locking cams on each end thereof, and wedge receivers on opposing sides thereof, to receive wedges at the top of said vertical support structures; said locking cams each comprising a rod with levers, said rods having a circular surface and a flat surface along the length thereof thereof.
